(19) United States
(12) Patent Application Publication
(10) Pub. No.: US 2008/0210561 A1
(43) Pub. Date: Sep. 4, 2008

(54) STABLE AQUEOUS DISPERSIONS OF ETHYLENE-AMINOALKYL METHACRYLATE COPOLYMERS

(76) Inventor: WALTER MAHLER, Wilmington, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/960,777

(22) Filed: Dec. 20, 2007

Related U.S. Application Data
(60) Provisional application No. 60/876,574, filed on Dec. 21, 2006.

(51) Int. Cl. C02F 1/461; C08J 3/05

(52) U.S. Cl. 205/80; 205/699

(57) ABSTRACT

Aqueous, cationic polyelectrolyte dispersions of improved stability are provided in which copolymers of ethylene and selected aminoalkyl acrylates and methacrylates are self dispersed in water with a mixture of phosphoric acid and at least one additional acid selected from alkylsulfonic acids and gallic acid.

This application claims the benefit of U.S. Provisional Application No. 60/876,574, filed 21 Dec. 2006, which is incorporated in its entirety as a part hereof for all purposes.

### TECHNICAL FIELD

This invention relates to stable, aqueous dispersions of ethylene copolymers, processes for their preparation and uses thereof.

### BACKGROUND

Copolymers of ethylene and aminoalkyl methacrylates are known and have been used for a variety of purposes, such as coatings and flocculating agents. In U.S. Pat. No. 3,711,435, there are provided stable, aqueous, cationic polyelectrolyte dispersions in which copolymers of about 20 to 80 percent by weight ethylene and about 80 to 20 percent by weight of selected aminoalkyl (meth)acrylates are self-dispersed in water with acids having a dissociation constant greater than 10⁻⁵. Such dispersions are prepared by stirring water, a copolymer and an acid in a vessel, preferably at a temperature above the melting point of the copolymer when the copolymer is of high molecular weight and ethylene content. While there are a number of uses for such dispersions, particularly preferred uses cited are: (1) cured, ultra-thin coatings on metallic substrates, particularly aluminum, (2) acid dyeable coatings on cellulosic substrates such as paper, and (3) flocculating agents for removing suspended matter from water.

Such dispersions are limited in situations where the aminoalkyl methacrylate comonomer is present at a minimum of 20 wt % in the copolymer. It is also desirable to increase further the stability of the dispersion, as measured, e.g., by the time until gel formation, while maintaining or increasing the allowed solids content. It is also desirable to be able to form and maintain such dispersions at reasonably low temperatures.

### SUMMARY

In one embodiment, this invention involves an aqueous, cationic polyelectrolyte dispersion, comprising a copolymer that comprises about 70 to about 90 percent by weight ethylene and about 10 to about 30 percent by weight of an aminoalkyl methacrylate as described by the structure of Formula (I):

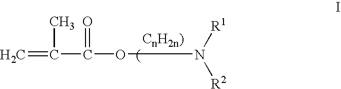

wherein R¹ and R² is each independently selected from the members of the group consisting of hydrogen and alkyl of 1 to 4 carbon atoms, and n is a positive integer of 1 to 4 inclusive; wherein the copolymer is dispersed in water with a mixture of H₃PO₄ and at least one additional acid selected from the group consisting of alkylsulfonic acids and gallic acid; and wherein the dispersion has a solids content within the range of about 5 to about 30 percent by weight.

In another embodiment, this invention involves a process for preparing an aqueous, cationic polyelectrolyte dispersion by (a) mixing (i) a copolymer that comprises about 70 to 90 percent by weight ethylene and about 10 to about 30 percent by weight of an aminoalkyl methacrylate as described by the structure of Formula (I):

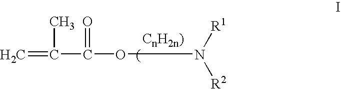

wherein R¹ and R² is each individually selected from the members of the group consisting of hydrogen and alkyl of 1 to 4 carbon atoms, and n is a positive integer of 1 to 4 inclusive; (ii) a mixture of H₃PO₄ and at least one additional acid selected from alkylsulfonic acids and gallic acid; and (iii) water sufficient to provide a solids content within the range of about 5 to 30 percent by weight; and (b) heating the mixture prepared in step (a) to produce a cationic polyelectrolyte dispersion from the components thereof.

In a further embodiment, this invention involves a coating, an adhesion promoter for a latex, a flocculant for treating water containing suspended matter, an acid dye, or a water-soluble epoxy prepared from the dispersion described above. The coating may, for example, be fabricated as a textile finish, a hair setting resin, a size for glass fibers, a detergent-resistant floor finish, or a coating on a metallic substrate.

### DETAILED DESCRIPTION

The usefulness of water-insoluble copolymers of ethylene and aminoalkyl methacrylates or methacrylates has been extended by this invention by dispersing them in water with a mixture of H₃PO₄ and at least one additional acid selected from alkylsulfonic acids and gallic acid. As used herein, the term “(meth)acrylate” means methacrylate and acrylate. The copolymer is dispersed as very small (less than 0.1 micron in diameter), positively charged particles which function as a surfactant for the dispersions and which also allow the dispersions to coalesce into very thin (less than 0.1 mil) pinhole-free coatings, for example, on aluminum.

The copolymer which forms the solid phase in the dispersions is a copolymer of ethylene and an aminoalkyl methacrylate compound. Such copolymers are described in U.S. Pat. No. 3,395,198, and their preparation is described in GB 1,221,918. Both patents are incorporated in their entirety as a part hereof for all purposes.

The copolymers used in the dispersions described herein contain about 70 to about 90 percent by weight ethylene and about 10 to about 30 percent by weight of an aminoalkyl methacrylate having the formula:

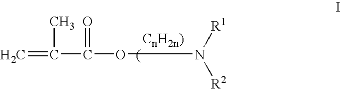

wherein R¹ and R² is each independently selected from the members of the group consisting of hydrogen and alkyl of 1 to 4 carbon atoms, and n is a positive integer of 1 to 4 inclusive.

Preferred aminoalkyl methacrylate compounds are N,N-dimethylaminoethyl methacrylate; aminoethyl methacrylate; N-methylaminoethyl methacrylate; N-t-butylaminoethyl methacrylate; and N-t-butylaminoethyl methacrylate. An especially preferred monomer is N,N-dimethylaminoethyl methacrylate as described by the structure of Formula (II).

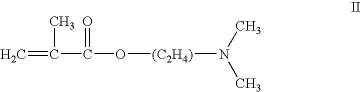

The acid mixture used to disperse the copolymer and give it the properties of a cationic polyelectrolyte is a mixture of phosphoric acid (H₃PO₄) and at least one additional acid selected from alkylsulfonic acids and gallic acid. The molar ratio of H₃PO₄ to the additional acid(s) can range from about 98:2 to about 50:50.

The dispersion is formed by mixing the copolymer, water and the acid mixture in ratios that provide a solids content within the range of about 5 to 30 percent by weight (preferably 10 to 20 percent by weight) and that neutralize the polymer amine groups such that the pH of the dispersion as prepared is in the range of from about 5.0 to about 6.5, at a temperature at which the copolymer will be dispersed, and preferably essentially self-dispersed, into a particle size less than 0.1 micron. Generally, the temperature employed will increase with increasing ethylene content. With the copolymers used herein, the mixture is typically heated at a temperature in the range of between about 100° C. and about 150° C. The achievable solids level will vary with the type of secondary acid used and the degree of neutralization. Vigorous stirring of the mixture is not needed; however, it does decrease the time needed to form the dispersion. The copolymer particles in the dispersion are cationically charged.

Other materials such as pigments, dyes, plasticizers, slip or anti-blocking agents, and fillers can be added to the dispersions of the present invention as modifiers.

Properties of the dispersions can also be modified by blending the dispersions with other polymeric lattices which are non-ionic or cationic in character. For example, adhesion of resulting coatings to substrates can be modified by blending the dispersions of the invention with polymeric lattices that are good adhesives such as a polyvinyl acetate emulsion, and a vinyl acetate/ethylene copolymer emulsion. The composition of the blended materials will depend upon which property is to predominate.

The dispersions described herein have many uses, for example, as components of textile finishing baths, as hair setting resins, as curing agents for water-soluble epoxies, as sizes for glass fibers, as coatings on various types of substrates including detergent-resistant floor finishes, as adhesion promoters for latexes, as flocculants for treating water containing suspended matter, and as means to fix acid dyes to cellulosics such as paper. They are particularly useful for forming thin pinhole-free coatings on metallic substrates such as aluminum.

### EXAMPLES

The advantageous attributes and effects of the compositions and processes hereof may be seen in a series of examples, as described below. The embodiments of these compositions and processes on which the examples are based are representative only, and the selection of those embodiments to illustrate the invention does not indicate that materials, conditions, arrangements, components, reactants, techniques or configurations not described in these examples are not suitable for practicing these processes, or that subject matter not described in these examples is excluded from the scope of the appended claims and equivalents thereof.

Viscosity was measured using a Brookfield viscometer. The following materials were used in the examples. Gallic acid (99% purity), methanesulfonic acid (98+% purity), and ethanesulfonic acid (95+% purity) were obtained from Aldrich Chemical Company (Milwaukee, Wis., USA). All commercial reagents were used as received. Ethylene copolymers were copolymerized in-house from ethylene and dimethylaminoethyl methacrylate.

### Example 1

10 g ethylene-23.6% dimethylaminoethylmethacrylate copolymer and 7.6 g gallic acid were heated with 100 g water at 100° C. to give a dispersion that was insoluble on cooling.

20 g ethylene-23.6% dimethylaminoethylmethacrylate copolymer and 3.1 g 85% phosphoric acid and 0.6 g gallic acid (molar ratio 1 dimethylamino to 0.1 gallic acid and 0.9 phosphoric acid) were heated with 100 g water at 100° C. to give a dispersion that did not gel in 30 days.

20 g ethylene-23.6% dimethylaminoethylmethacrylate copolymer and 3.5 g 85% phosphoric acid and 0.4 g gallic acid (molar ratio 1 dimethylamino to 0.07 gallic acid and 1.0 phosphoric acid) were heated with 150 g water at 100° C. to give a dispersion that did not gel in 8 days.

Results are summarized in Table 1.

TABLE 1

| | |
|---|---|
| Moles acid | |
| relative to DMAEM | Gel Time |

| H₃PO₄ | Gallic Acid | wt % solids | (days) |
|---|---|---|---|
| 0 | 1 | 14 | 0 |
| 1 | 0.07 | 14 | >8 |
| 0.9 | 0.1 | 20 | >30 |

### Example 2

60 g ethylene-16% dimethylaminoethylmethacrylate copolymer was heated with 7.2 g 85% phosphoric acid (corresponding to a 1:1 mole ratio) and 540 mL of water in a beaker on a hot-plate. After 25 minutes at 100° C., the product was a thick viscous fluid.

60 g ethylene-16%dimethylaminoethylmethacrylate copolymer was heated with 3.6 g 85% phosphoric acid and 3 g methanesulfonic acid (corresponding to 0.5 mole ratio of each component) and 540 mL of water in a beaker on a hot-plate. After 30 minutes at 100° C. and cooling, the product was a low viscosity fluid.

The above experiment was repeated with various ratios of phosphoric acid and methanesulfonic acid, keeping a 1:1 molar ratio of the ethylene-16% ethylene dimethyl aminoethylmethacrylate to the sum of the acids and a solids concentration of 10 wt %. Similar experiments were done using ethanesulfonic acid. The viscosity of the products is shown in Table 2. The lowest viscosity was obtained using molar ratio of 90-50:10:50 phosphoric acid to methanesulfonic acid.

For comparison, a mixture was prepared using sulfuric acid instead of phosphoric acid, and methanesulfonic acid as the secondary acid. No reaction occurred and no dispersion was formed.

TABLE 2

| | | Viscosity |
|---|---|---|
| Mole % acid | | (cp) |
| Phosphoric | Methanesulfonic | |
| 100 | 0 | 11000 |
| 95 | 5 | 2720 |
| 90 | 10 | 48 |
| 80 | 20 | 52 |
| 50 | 50 | 40 |
| 0 | 100 | 96 |
| Phosphoric | Ethanesulfonic | |
| 98 | 2 | 1280 |
| 96.5 | 3.5 | 928 |
| 93 | 7 | 352 |
| Sulfuric | Methanesulfonic | |
| 90 | 10 | No |
| | | dispersion |

Where a range of numerical values is recited herein, the range includes the endpoints thereof and all the individual integers and fractions within the range, and also includes each of the narrower ranges therein formed by all the various possible combinations of those endpoints and internal integers and fractions to form subgroups of the larger group of values within the stated range to the same extent as if each of those narrower ranges was explicitly recited. Where a range of numerical values is stated herein as being greater than a stated value, the range is nevertheless finite and is bounded on its upper end by a value that is operable within the context of the invention as described herein. Where a range of numerical values is stated herein as being less than a stated value, the range is nevertheless bounded on its lower end by a non-zero value.

In this specification, unless explicitly stated otherwise or indicated to the contrary by the context of usage, amounts, sizes, ranges, formulations, parameters, and other quantities and characteristics recited herein, particularly when modified by the term “about”, may but need not be exact, and may also be approximate and/or larger or smaller (as desired) than stated, reflecting tolerances, conversion factors, rounding off, measurement error and the like, as well as the inclusion within a stated value of those values outside it that have, within the context of this invention, functional and/or operable equivalence to the stated value.

In this specification, unless explicitly stated otherwise or indicated to the contrary by the context of usage, where an embodiment of the subject matter hereof is stated or described as comprising, including, containing, having, being composed of or being constituted by or of certain features or elements, one or more features or elements in addition to those explicitly stated or described may be present in the embodiment. An alternative embodiment of the subject matter hereof, however, may be stated or described as consisting essentially of certain features or elements, in which embodiment features or elements that would materially alter the principle of operation or the distinguishing characteristics of the embodiment are not present therein. A further alternative embodiment of the subject matter hereof may be stated or described as consisting of certain features or elements, in which embodiment, or in insubstantial variations thereof, only the features or elements specifically stated or described are present.

What is claimed is:

1. An aqueous, cationic polyelectrolyte dispersion, comprising a copolymer that comprises about 70 to about 90 percent by weight ethylene and about 10 to about 30 percent by weight of an aminoalkyl methacrylate as described by the structure of Formula (I): 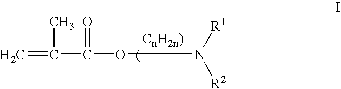
wherein R¹ and R² is each independently selected from the members of the group consisting of hydrogen and alkyl of 1 to 4 carbon atoms, and n is a positive integer of 1 to 4 inclusive;
wherein the copolymer is dispersed in water with a mixture of H₃PO₄ and at least one additional acid selected from the group consisting of alkylsulfonic acids and gallic acid; and
wherein the dispersion has a solids content within the range of about 5 to about 30 percent by weight.

2. The dispersion of claim 1 wherein the aminoalkyl methacrylate is selected from the group consisting of N,N-dimethylaminoethyl methacrylate; aminoethyl methacrylate; N-methylaminoethyl methacrylate; N-t-butylaminoethyl methacrylate; and N-t-butylaminoethyl methacrylate.

3. The dispersion of claim 1 wherein the copolymer comprises about 70 to about 90 percent by weight ethylene and about 10 to about 30 percent by weight aminoalkyl methacrylate.

4. The dispersion of claim 1 wherein the solids content is in the range of about 10 weight percent to about 20 weight percent.

5. The dispersion of claim 1 wherein the alkylsulfonic acid comprises methanesulfonic acid or ethanesulfonic acid.

6. The dispersion of claim 1 wherein the molar ratio of H₃PO₄ to the additional acid(s) is in the range of about 98:2 to about 50:50.

7. A process for preparing an aqueous, cationic polyelectrolyte dispersion, comprising:
(a) mixing (i) a copolymer that comprises about 70 to 90 percent by weight ethylene and about 10 to about 30 percent by weight of an aminoalkyl methacrylate as described by the structure of Formula (I): 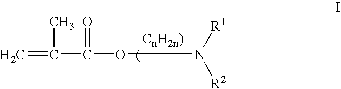
wherein R¹ and R² is each individually selected from the members of the group consisting of hydrogen and alkyl of 1 to 4 carbon atoms, and n is a positive integer of 1 to 4 inclusive; (ii) a mixture of H₃PO₄ and at least one additional acid selected from alkylsulfonic acids and gallic acid; and (iii) water sufficient to provide a solids content within the range of about 5 to 30 percent by weight; and
(b) heating the mixture prepared in step (a) to produce a cationic polyelectrolyte dispersion from the components thereof.

8. The process of claim 7 wherein the mixture is heated at a temperature in the range of from about 100° C. to about 150° C.

9. The process of claim 7 wherein the aminoalkyl methacrylate is selected from the group consisting of N,N-dimethylaminoethyl methacrylate; aminoethyl methacrylate; N-methylaminoethyl methacrylate; N-t-butylaminoethyl methacrylate; and N-t-butylaminoethyl methacrylate.

10. The process of claim 7 wherein the copolymer comprises about 70 to about 90 percent by weight ethylene and about 10 to about 30 percent by weight aminoalkyl methacrylate.

11. The process of claim 7 wherein the solids content is in the range of about 10 weight percent to about 20 weight percent.

12. The process of claim 7 wherein the alkylsulfonic acid comprises methanesulfonic acid or ethanesulfonic acid.

13. The process of claim 7 wherein the molar ratio of H₃PO₄ to the water-soluble organic acid is in the range of about 98:2 to about 50:50.

14. A coating, an adhesion promoter for a latex, a flocculant for treating water containing suspended matter, an acid dye, or a water-soluble epoxy prepared from the dispersion of claim 1.

15. A coating according to claim 14 wherein fabricated as a textile finish, a hair setting resin, a size for glass fibers, a detergent-resistant floor finish, or a coating on a metallic substrate.
